(19) United States
(12) Patent Application Publication
(10) Pub. No.: US 2008/0153723 A1
(43) Pub. Date: Jun. 26, 2008

(54) DIESEL CYLINDER LUBRICANT OIL COMPOSITION

(75) Inventors: Cornelis Hendrikus Maria Boons, Breda (NL); Marcel Verlinde, Lage Zwaluwe (NL); Dirk Jan Elzo Vrolijk, Kruisland (NL)

Correspondence Address: CHEVRON CORPORATION, P.O. BOX 6006, SAN RAMON, CA, 94583-0806, US

(73) Assignee: Chevron Oronite Company LLC

(21) Appl. No.: 11/613,939

(22) Filed: Dec. 20, 2006

(51) Int. Cl. C10M 125/04; C09K 15/08

(52) U.S. Cl. 508/150; 508/110; 508/567; 508/584

(57) ABSTRACT

Provided are Formulations, methods of making, and methods of using a diesel cylinder lubricating oil composition to achieve enhanced corrosive wear-control on the cylinders of a 2-stroke diesel engine, wherein such lubricating oil composition comprises, among other things, an amount of one or more surfactant materials sufficient to provide substantially improved capacity to reduce or inhibit corrosive wear.

The present invention relates to lubricant oil compositions suitable for use in two-stroke diesel engines. In particular, the present invention relates to diesel cylinder lubricant oil compositions. More particularly, the lubricant oil compositions of the present invention may be used to lubricate the power cylinders in diesel engines burning fuels that have conventional sulfur levels or those that have lower sulfur levels. Each of the diesel cylinder lubricant oil compositions of the present invention comprises, inter alia, one or more surfactant materials that impart improved capacity to control the corrosive-wear on the power cylinders. Moreover, the corrosive wear-controlling surfactant materials of the present invention are compatible with, conventional diesel cylinder lubricant oils that have total base numbers (“TBN”) of at or above 70 (“high TBN oils”). These surfactant materials are also compatible with diesel cylinder lubricant oils of lower TBNs,/which may in turn be preferably used to lubricate engines powered by fuels that contain lower-than-conventional levels of sulfur. Furthermore, the present invention is concerned with methods of providing enhanced protection against corrosive wear, while preventing excessive deposit buildups, and providing lubrication to the cylinders in 2-stroke diesel engines. The present invention also relates to the methods of preparing such diesel cylinder lubricant oil compositions.

In the not so distant past, rapidly escalating energy costs, particularly those incurred in distilling crude oil and liquid petroleum, became burdensome to the users of transportation Fuels, such as owners and operators of seagoing ships. In response, those users have steered their operations away from steam turbine propulsion units in favor of large marine diesel engines that are more fuel efficient. Diesel engines may generally be classified as slow-speed, medium-speed, or high-speed engines, with the slow-speed variety being used for the largest, deep shaft marine vessels and certain other industrial applications. Slow-speed diesel engines are unique in size and method of operation. The engines themselves are massive, the larger units may approach 200 tons in weight and an upward of 10 feet in length and 45feet in height. The output of these engines can reach as high as 50,000 brake horsepower with engine revolutions' of more than 100 revolutions per minute. They are typically of crosshead design and operate on the two-stroke cycle. Medium-speed engines, on the other hand, typically operate in the range of about 250 to about 1100 rpm and may operate on either the four-stroke or the two-stroke cycle. These engines can be of trunk piston design or occasionally of crosshead design. They typically operate on residual fuels, just like the slow-speed diesel engines, but some may also operate on distillate fuels that contain little or no residue. These engines can also be used for propulsion, ancillary applications or both on deep-sea vessels. Slow- and medium-speed diesel engines are also extensively used in power plant operations. The lubricant oil compositions and methods of the present invention are applicable to those operations as well.

A slow- or medium-speed diesel engine that operates on the 2-stroke cycle is typically a direct-coupled and direct-reversing engine of crosshead construction, with a diaphragm and one or more stuffing boxes separating the power cylinders from the crankcase to prevent combustion products from entering the crankcase and mixing with the crankcase oil. The notable complete separation of the crankcase from the combustion zone has led persons skilled in the art to lubricate the combustion chamber and the crankcase with different lubricating oils. The corrosive wear-controlling surfactant materials and lubricant oil compositions of the present invention may be advantageously applied to lubricate the power cylinders of these diesel engines, although there is no reason to believe that these additives or compositions, with slight modification of low-temperature properties such as viscosity, would not be suitable for lubricating the crankcases as well,

Traditionally, fuels used for diesel engines have a high sulfur content of at least 3.5%, and typically of at least 4.5%. The high sulfur levels in diesel fuels has led to the generation and release of large amounts of sulfur oxides (SOₓ) in the exhaust gases. Aside from polluting the air, the sulfur oxides react with the moisture that is also present in the exhaust gases to form sulfuric acid, which in turn corrodes the engine. To combat acidic corrosion, persons skilled in the art have formulated diesel cylinder lubricant compositions to include various overbased metallic detergents, which are capable of neutralizing the sulfuric acid. For example, conventional marine diesel cylinder lubricant compositions typically have a total base number (“TBN”) of at least 70 (as determined using ASTM D2896). Those conventional diesel cylinder lubricant compositions are referred to as “high TBN oils” herein.

In recent years, legislations in various countries and regions of the world sought to reduce pollution from diesel engines of ships and other industrial applications by including measures to reduce the amount of sulfur in marine fuels. For example, the International Maritime Organization's MARPOL Annex VI “Regulations for the Prevention of Air Pollution from Ships” has imposed stricter pollution regulations, including limits on sulfur oxide. In some geographic areas, often called “SOₓ Emission Control Areas,” or “SECAs,” restrictions on sulfur in fuel are particularly stringent. Those areas include, for example* the Baltic Sea and the North Sea. Some regulations have already been implemented while others are promulgated but awaiting implementation. For example, in May of 2005, a cap of 4.5% sulfur in diesel fuel was imposed globally, In May of 2006, a cap of 1.5% sulfur was imposed in the Baltic Sea, In August 2007, a cap of 1.5% sulfur will be imposed in the North Sea.

As a result of the gradual implementation of these regulations, the levels of Sulfur in diesel fuels vary currently depending on the countries and/of regions. Accordingly, an oceangoing vessel may be required to use diesel fuels having a level of sulfur below 1.5% in some parts of the world, but as it navigates to some other areas, be required to use diesel fuels having a level of sulfur as high as 4.5%, Certain diesel cylinder lubricant oils have been formulated specifically for the SECAs where the sulfur levels in diesel fuels are below 1.5%. These lubricant oils are called “low TBN oils,” because they typically have a TBN of at or below 40. Operators of stationary diesel engines in the SECAs as well as ship owners who operate exclusively or primarily in those areas also have the option to continue to use the conventional high TBN oils (i.e., lubricant oils with a TBN of at or above 70), but they must apply those oils at a slower feed rate to avoid producing excessive hard deposits on the cylinders due to high thermal loads on unreacted neutralizing additives. This approach, though theoretically feasible, is often prohibitively cumbersome in practice, because it requires that the operator of the diesel engines monitor the cylinders continuously and adjust the feed rate according to the levels of deposits and wear lie observes. This reduction and continued adjustment of feed rate is necessary to prevent not only the excess hard deposits, but also the loss of controlled corrosion when a high TBN oil is used in a low sulfur environment. The excess hard deposits would otherwise form primarily on the crown land and impact the oil film, leading to scuffing and ultimately to deposits behind the rings and the ring grooves, A high TBN oil applied at its usual feed rate in a low-sulfur environment will reduce corrosion so much that the liner surfaces become too smooth and unable to hold the lubricant oil. This over-reduction of corrosion is also known as “lack of controlled corrosion,” and will in turn lead to wear and continued polishing of the liner's surface. Scuffing as a result of direct metal-to-metal contact is inevitable in a prolonged absence of controlled corrosion. Thus, prudent users of diesel engines who operate exclusively or primarily in the SEC As typically switch entirely to low TBN oils for their lubrication needs rather than undertake the delicate task of continuously adjusting the feed rate of high TBN oils in accordance with the changing engine conditions.

Majority of the world's deep sea fleet, however, is represented by ships that operate only part time in the SECAs. These ships typically travel and/or operate at sea for weeks if not months at a time, therefore, must carry lubricants onboard to replenish or replace used oils, so that their engines are effectively lubricated and protected from the perils; of harsh operating conditions. While it is possible for an owner or operator of such a ship to carry onboard only a high TBN oil, using it at the full feed rate in the non-SECAs and at reduced feed rate in the SECAs, the exacting requirement of monitoring the power cylinders and adjusting the feed rate according to the levels of hard deposits makes this approach disagreeable. It is also a risky approach. Under certain circumstances where very low sulfur diesel fuels must be used, the feed rates may need to be so low that substantial engine wear may occur. It has thus become the preferred approach for ship owners or operators to carry onboard both a high TBN oil and a low TBN oil, so that a choice between those two oils can be made depending on the levels of sulfur in the available diesel fuels.

In the long term, all areas or regions of the world will likely he requiring low-sulfur diesel fuels. In the near future, however, ship owners or operators would continue to carry both a low TBN and high TBN cylinder lubricant oil onboard their vessels. An alternative, or perhaps more preferred, approach may be to carry various additives onboard-ships as oil-concentrates so that lubricants can be blended in situ according to both the diesel fuel types and the conditions (e.g., levels of wear and deposits) of the cylinders. The present invention pertains to certain corrosive wear-control surfactant materials that can be made into oil concentrates and serve this purpose competently. Those additives are compatible with both high TBN and low TBN oils, thus can be blended into the lubricant oils for applications in both the SECAs and the non-SECAs.

Corrosive wear is a well-known problem in diesel engines. This type of wear distinguishes from physical wear or scuffing caused by direct contact of moving metal surfaces. To combat scuffing or physical wear, persons skilled in the art typically use friction modifiers, which are known to simply reduce the friction between surfaces that come into contact with each other during operation, thus reducing wear to these surfaces. Specifically, as the surfaces move closer together, the lubricant is squeezed out between them. During this process, the friction modifier molecules in the lubricant become adsorbed onto the surfaces, thereby retained between the surfaces, displaying a molecular orientation perpendicular to the surfaces, reducing the level of contact and lowering the friction.

As illustrated above, there is a limit to how much one might increase the TBN of a given lubricant oil, even though it might theoretically be possible to neutralize all of the sulfuric acid produced during combustion, because of concerns for hard deposits and loss of controlled erosion. As a result, persons skilled in the art use certain other additives to supplement corrosive wear control. Examples of such additives include various zinc-containing compounds. For example, U.S. Pat. No. 4,842,755 disclosed a marine diesel cylinder lubricant having a base number of at least 60. The composition includes a borated ashless dispersant, one or more overbased metal compounds and a zinc dialkyl dithiophosphate providing 0.02 to 0.23wt. % (200 to 230 ppm) of zinc. Notably, increasing the amount of zinc above about 230 ppm unexpectedly led to a loss of performance benefits in ring and linear wear. U.S. Pat. No. 4,948,522 disclosed marine diesel cylinder lubricants comprising a borated dispersant and a polybutene, and optionally a zinc dialkyldithiophosphate and/or overbased metal detergent. Those lubricants were said to have improved ring wear and liner wear performance and good protection against corrosion. U.S. Pat. No, 6,140,280 disclosed succinimide compounds that exhibit corrosion resistenace and wear resistance in diesel engines. It also disclosed that conventional anti-wear agents such as zinc dithiophosphates and molybdenum dithiocarbamates, maybe used as co-additives to boost resistance to corrosive wear.

With the development of low TBN lubricant oils, the need for corrosive wear control becomes more acute. Even with the low sulfur levels in the fuels, the parts in the diesel engines remain exposed to sulfuric acid in the exhaust. At such low TBN levels, the sulfuric acid produced during combustion are typically not effectively neutralized. Certain additives have been found to enhanced corrosive wear control in a low TBN environment. For example, in U.S. patent application Ser. No. 10/947,093 (published as US 2005/0153847 A1, on Jul. 14, 2005), a marine diesel cylinder lubricant composition having a total base number of at least 30, preferably at least 35 or more, comprising (a) at 40 wt. % of an oil of lubricating viscosity; (b) at least one detergent prepared from at least two surfactants, preferably phenate and sulfonate surfactants; (c) at least one boron-containing dispersant providing at least 100 ppm of boron; and (d) at least one zinc-containing antiwear additive preferably a zinc dihydrocarbyl dithiophosphate providing more than 230 ppm, preferably at least 250 ppm, of zinc. That lubricant composition was said to provide improved protection against corrosive wear in the presence of 230 ppm of zinc, and was said to provide good wear protection even at a low total base number, such as for example, when used in a high sulfur environment. U.S. patent application Ser. No. 11/265,838 (published as US 2006/0116298 A1 on Jun. 1, 2006), disclosed a lubricant oil composition that purportedly offered effective cylinder liner protection, particularly in the-areas of the cylinder that are prone to corrosive wear. That composition comprised (a) a major amount of oil of lubricating viscosity; and (b) a minor amount of m oil-soluble or oil-dispersible molybdenum compound, and had a TBN of from 20 to 100 and a viscosity at 100° C. in the range of from 9 to 30 mm²s⁻¹.

We have found surprisingly that certain surfactant materials, when included in a lubricating oil composition for 2-stroke diesel engine cylinders, substantially enhance the capacity of the oil to prevent corrosive wear on those cylinders. Moreover, their capacity to control corrosive wear is not affected by the TBN of the lubricant oil composition. Furthermore, these surfactant materials provide enhanced corrosive wear control without adding to the extent of overbasing in the lubricant oil, making them particularly suitable for use as additives in low TBN oils. Those additives are divergent in their mechanisms of action, although all can be categorized structurally as surfactants or surfactant-related materials.

This finding offers new possibilities for controlling corrosive wear in 2-stroke diesel engines, especially those that drive seagoing vessels operating in both low and high sulfur fuel regions. The surfactant materials of the invention offer particular advantages if an owner or operator of a vessel opts to take various lubricant additives onboard as oil concentrates, blending them into lubricant oils that would suit the real-time lubrication needs. The finding of these materials allows the owner/operator to carry on board a single type of corrosive-wear inhibitor that can be blended into low TBN oils, high TBN oils, and oils that have intermediate TBNs as a result of mixing various proportions of low TBN oils and high TBN oils. Furthermore, because at least some of these additives are equally known to provide dispersancy, their oil concentrates can serve multiple purposes, further reducing the number of additives that must be carried onboard seagoing vessels.

The present invention thus provides; 2-stroke diesel cylinder lubricant compositions comprising various oil-soluble surfactant materials that demonstrate enhanced protection against corrosive wear. The term “oil-soluble” as used herein refers to compounds that are soluble under normal blending conditions in the base stocks or in an additive package. The present invention further provides methods for preparing these diesel cylinder lubricant compositions and using them to prevent corrosive Wear of power cylinders in 2-stroke diesel engines. Moreover, the present invention provides methods of blending an oil-concentrate of these surfactants m situ with one or more other suitable components into diesel cylinder lubricant compositions, and using such blended compositions to lubricate and protect 2-stroke diesel engines from corrosive wear,

### SUMMARY

It has been found that the inclusion of one or more surfactant materials in certain 2-stroke diesel cylinder lubricant compositions improves the ability of the lubricant compositions to protect the power cylinders from corrosive wear. This protection has been observed regardless of whether the diesel engine at issue burns a high-sulfur heavy diesel fuel oil (i.e., having a sulfur level of about 1.5% to about 4.5%) or a low-sulfur heavy diesel fuel oil (i.e., having sulfur level of at or below about 1.5%), One or more surfactant materials of the present invention can be blended into a diesel cylinder lubricant composition before the composition is loaded onboard seagoing vessels, but may also be carried onboard as an oil-concentrate, to be blended in situ according to the real-time lubrication needs and fuel types.

The first aspect of the present invention pertains to a corrosive-wear reducing and/or inhibiting oil-soluble surfactant material suitable as an additive to a diesel cylinder lubricant oil composition. The additive's ability to control corrosive wear is not the result of high TBN. Nor is it affected by the TBN of the lubricant oil composition to which the inhibitor is a part. The diesel cylinder lubricant oil composition of this aspect can be used to lubricate the cylinders of a 2-stroke diesel engine that bums heavy diesel fuels containing as low as less than about 1.5% and/or as high as about 4.5% of sulfur. The additive of this aspect may also be in an oil concentrate form.

The second aspect of the present invention pertains to a diesel cylinder lubricant composition with improved corrosive wear control properties comprising a corrosive wear inhibitor of the first aspect. The diesel cylinder lubricant composition of this aspect can be used to lubricate the cylinders of 2-stroke diesel engines burning any currently available diesel fuels.

This invention, in its third aspect, provides a method of making a diesel cylinder lubricant composition of the second aspect, in this aspect, the invention also provides a method of blending a diesel cylinder lubricant composition of the second aspect onboard a sea-going vessel using an oil-concentrate of a corrosive-wear inhibitor of the first aspect, the amount of which depending on the real-time lubrication needs and/or the extent of wear of the particular cylinders to be lubricated.

In its fourth aspect, this invention pertains to a method of providing and maintaining optimal levels of protection for the cylinders of a 2-stroke diesel engine against corrosive wear by applying a lubricant composition of the second aspect.

Persons skilled in the art will understand other and further objects, advantages, and features of the present invention by reference to the following description.

### DETAILED DESCRIPTION OF THE INVENTION

Various preferred features and embodiments are described below by way of non-limiting Illustrations.

### 1. Surfactant Materials

The present invention relates to a lubricant oil composition suitable for reducing arid/or inhibiting corrosive wear on the power cylinders of 2-stroke diesel engines, comprising one or more certain oil-soluble surfactant materials. Specifically, the oil-soluble surfactants of the present invention are molecules that have traditionally been associated with deposit control or dispersancy, but are not known to-control corrosive-wear. Moreover, the surfactant materials of the present invention can he carried on board seagoing vessels as an integral (i.e., blended) part of a marine cylinder lubricant, or as an oil concentrate that is later blended in situ depending, on the contemporaneous sulfur levels of the diesel fuels, the particular lubrication needs of the 2-stroke diesel engines, and the extent of wear on the cylinders. Furthermore, the surfactant materials of the present invention, when incorporated in a sufficient amount into either a high TBN oil or a low TBN oil, can effectively reduce corrosive wear on the cylinders of 2-stroke diesel engines regardless of the sulfur levels in the fuels that drive those engines. Aside from reducing or inhibiting corrosive wear, some of these oil-soluble surfactant materials retain their traditional capacity to provide dispersancy, therefore allowing their use as multi-functional additives.

As used herein, the term “surfactant material” refers to a molecule that have surfactant properties and can be classified a surfactant. It also refers to a molecule that is derived from such a surfactant, which is not so substantially changed from the surfactant precursor as to lose the surfactant characteristics. As it is understood by those skilled in the art, a surfactant is a material that can reduce the surface tention of water by at least 5%, or at least 10%, or at least 20%, or at least 30%, or at least 40%, when used in even small amounts.

A surfactant molecule typically comprises a hydrophobic end and a hydrophilic end. The hydrophobic end of a surfactant .molecule is generally about 8 to about 20 carbon atoms long; This end can be aliphatic, aromatic, or a mixture of both. The sources from which the hydrophobic end of the molecule may be derived include, for example, natural fats and/or oils, petroleum fractions, relatively short synthetic polymers, or relatively high molecular weight synthetic alcohols.

While the hydrophobic end of a surfactant is important, persons skilled in the art typically classify each surfactant based on its hydrophilic end. There are four classes of surfactants: (1) anionic surfactants; (2) cationic surfactants: (3) non-ionic surfactants; and (4) zwitterionic surfactants. In an anionic surfactant, the hydrophilic end comprises an anionic group. Anionic hydrophophilic groups may be, for example, carboxylates, sulfates, sulfonates, and phosphates. Accordingly, anionic surfactants may be, for example, sodium dodecyl sulfate (SDS), ammonium lauryl sulfate, and other alkyl sulfate salts; sodium laureth sulfate, also known as sodium lauryl ether sulfate (SEES); alkyl benzene sulfonate; and fatty acid salts. In a cationic surfactant, the hydrophilic end comprises a cationic group. Cationic hydrophilic groups are most often derived from a quaternary ammonium cation of the structure NR₄⁺ with the R's being alkyl groups. Examples of cationic surfactants include cetyr trimetliylammonium bromide (CTAB), also known as hexadecyl trimethyl ammonium bromide; other alkyltrimethylammonium salts; cetylpyridinium chloride (CPC); polyethoxylated tallow amine (POEA); benzalkonium chloride (BAC); and benzethonium chloride (BZT). In a non-ionic surfactant, the non-ionic hydrophilic group Is typically associated with water at the ether oxygens of a polyethylene glycol chain. Non-ionic surfactants may be, for example, alkyl poly(ethylene oxide); alkyl polyglucosides, such as octyl glucoside and decyl maltoside; various fatty alcohols, such as cetyl alcohol and oleyl alcohol; various cocamide derivatives that can be prepared from fatty acids of coconut oils, such as cocamide MEA, cocamide DEA, and cocamide TEA. A surfactant may also contain two oppositely charged groups on one or more of hydrophilic ends. In that case, the surfactant is a zwitterionic surfactant. A zwitterionic surfactant molecule is electrically neutral when it is at the Isoelectric point Zwitterionic surfactants may be, for example, dodecyl betaine; dodecyl dimethylamine oxide; cocamidopropyl betaine; and coco ampho glycinate. Regardless the type, surfactant molecules form clusters in water when present in a concentration higher than a certain threshold. In those clusters the hydrophilic ends of the molecules line up on the outside of the cluster, facing the water, while the hydrophilic ends of the molecules point inward. If the surfactant molecules are present in an oil, then a reverse cluster may form, with the hydrophobic ends of the molecules pointing outward towards the oil and the hydrophilic ends pointing inward. These clusters are called micelles, and they are typically formed when: the concentration of the surfactants reaches a certain threshold. Such a threshold is in turn called “critical micelle concentration.”

Certain of the surfactant materials of the present invention may have characteristics of detergents. Unlike detergents typically used as additives to diesel cylinder lubricant oils, however, the surfactant materials of the present invention are generally not overbased or only very slightly overbased. The TBN of a suitable surfactant molecule is typically at or below about 50, such as below about 20, preferably from about 0 to about 17. As conventionally defined, the degree of overbasing is the number of equivalents of the metal base per equivalent of the acid substrate. The total base number, or TBN, of a given molecule reflects its ability to neutralize acids. Typically, a molecule is said to be non-overbased when it has a TBN of about 0. A low overbased molecule has a TBN of above 0 but below-about 60. A highly overbased molecule has a TBN of about 60 to as high as about 500.

In an exemplary embodiment of the present invention, a sulfonate surfactant material that may also be characterized as a detergent is added to a diesel cylinder lubricant oil composition to provide enhanced corrosive wear control, but the TBN of the lubricant oil is primarily provided for by a pair of other highly overbased, detergents. In that embodiment, then, the overbasing in the detergents provides the acid-neutralizing capacity to the lubricant oil composition, while the surfactant of the present invention provides the enhanced corrosive wear control. Typically, a surfactant material of the present invention contributes less than about 10%, more preferably, less than about 5%, or less than about 2%, of the TBN to the lubricating oil composition to which it is a part.

Certain other suitable surfactant materials of the present invention may have characteristics of dispersants. Accordingly, that surfactant material may serve in dual capacity as a dispersant and a corrosive-wear inhibitor in the diesel cylinder lubricant oil composition to which it is a part. In that case, the surfactant material of the present invention is generally metal-free and thus does not lead to ash formation. In addition to preventing or reducing corrosive wear on the power cylinders, that surfactant material also serves to suspend deposits or precursors of deposits in oil. That surfactant material may suspend deposits or precursors of deposits by, for example, including the undesirable polar species into micelles; associating with colloidal particles, thereby preventing them from aggregating and falling out of solution; suspending aggregates after they are formed in the bulk lubricant; modifying soot particles to prevent aggregation; or lowering the surface/interfacial energy of the polar species to prevent their adherence to metal surfaces.

A diesel cylinder lubricant oil composition of the present invention comprises one or more surfactant materials as described above. The one or more surfactant materials are suitably present in the lubricant oil composition in an amount sufficient to offer substantially improved capacity to Inhibit or reduce the corrosive wear. The term “inhibit or reduce” as used herein, refers to a reduction in corrosive wear that is measurable in a properly designed bench or engine test mimicking the conditions under which a 2-stroke diesel engine typically operate. An example of such an engine test is the Bolnes Engine Test, as described in various recent U.S. patent applications, including, for example, U.S. patent application Ser. No. 10/481,486(published as US 2004/0235684 Al on November 25, 2004), and U.S. patent application Ser. No. 10/947,093 (published as US 2005/0153847 A1 on Jul. 14, 2005). Disclosures of these applications, to the extent they are relevant to the Bolnes Engine Test, and to the extent they do not conflict with the disclosures and claims herein, are incorporated by reference. An example of an art-accepted bench test is the Falex™ Pin and Vee-Block Method, as described, for example, on page 393 of the FUELS and LUBRICANTS HANDBOOK: TECHNOLOGY, PROPERTIES, PERFORMANCE, AND TESTING (Totten ed. ASTM International, West Conshohocken, Pa. 2003). The term “substantially improved” as used herein refers to improvements mat are at least 2%, or at least 5%, or even at least 10%, as compared to the results generated by a sample containing no such surfactant material.

Advantageously, the one or more surfactant materials of the present invention may be present in the diesel cylinder lubricant: oil composition in an amount of about 2 wt. % to about 25 wt. %. Preferably, however, the one or more surfactant materials may be present in the diesel cylinder lubricant oil in an amount of about 4 wt. % to about 20 wt. %, or about 5% to about 15 wt. %. In an exemplary embodiment of the present invention, the surfactant material employed to inhibit or reduce corrosive wear in a diesel cylinder lubricating oil is a mixture, of C₁₈ to C₂₈, linear alkyl phenol isomers present In an amount of about 7 wt. %, based on the total weight of the lubricating oil composition. In another exemplary embodiment of the present invention, the surfactant material employed is a low-overbased (having a TBN of about 17) calcium sulfonate, present in an amount of about 8 wt. %, based on the total weight of the lubricating oil composition.

### 2. Oil of Lubricating Viscosity

The oil of lubricating viscosity may be any oil suitable for the lubrication of large diesel engines including, for example, cross-head engines or trunk piston engines. The lubricating oil may suitably be an animal, a vegetable or a mineral oil. The lubricating oil may further be a petroleum-derived lubricating oil such as, for example, a naphthenic-base, paraffinic-base, or mixed-base oil. Alternatively the lubricating oil may be a synthetic lubricating oil. Suitable synthetic lubricating oil include, for example, synthetic ester lubricating oils, which oils include diesters such as di-octyl adipate, di-octyl sebactate and tri-decyl adipate; or polymeric hydrocarbon lubricating oils such as liquid polyisobutyene and poly alpha olefins. Often, a mineral oil is employed in this capacity.

Another class of lubricating oils suitable for purposes of this invention is hydrocracked oils, where the refining process further breaks down the middle- and heavy-distillate fractions in the presence of hydrogen at high temperature and moderate pressures. Hydrocarcked oils typically have kinematic viscosity at 100° C. of from 2 to 40, for example, from 3 to 15 mm²s⁻¹ and a viscosity index in the range of from 100 to 110, for example, from 105to 108.

The term “brightstock” is used by persons skilled in the art to refer to base oils that are solvent-extracted, de-asphalted products from vacuum residuum. They generally have a kinematic viscosity at 100° C. of from 28 to 36 mm²s⁻¹, and are typically used in proportion of less than 50, such as less than 40, more preferably less than 35 wt. %, based on the total weight of the lubricating oil composition. An exemplary diesel cylinder lubricant composition of the present invention comprised an ESSO™ Core 2500 Base Oil that is a brightstock in an amount of about 35 wt. %, as part of a mixture with another non-brightstock base oil.

The diesel cylinder lubricant composition of the present invention includes a major amount of an oil of lubricating viscosity. By “a major amount” it is meant that the diesel cylinder lubricant composition suitably includes at least about 40 wt. %, preferably at least about 50 wt. %, more preferably at least about 60 wt. %, and particularly preferably, at least about 70 wt. %, of an oil of lubricating viscosity as described above, based on the total weight of the diesel cylinder lubricant oil composition.

### 3. Overbased Metal Detergents

The diesel engine cylinder lubricant of the present invention may further comprise one or more overbased metal detergents. An overbased metal detergent molecule typically comprises a surfactant part and a metal part. The surfactant part of the overbased metal compound preferably contains at least one hydrocarbyl group, for example, as a substituent on an aromatic ring. An example of substituted aromatic ring is a phenol group. The term “hydrocarbyl” as used herein means that the group concerned is primarily composed of hydrogen and carbon atoms and is bonded to the remainder of the molecule via a carbon atom, but does not exclude the presence of other atoms or groups in a proportion insufficient to detract from the substantially hydrocarbon characteristics of the group. Advantageously, the one or more hydrocarbyl groups in the surfactant part of the metal detergent of the present invention are aliphatic groups, preferably alkyl or alkylene groups, especially alkyl groups, which may in turn be linear or branched. The total number of carbon atoms in hydrocarbyl groups in the surfactant part of a suitable overbased metal detergent is at least sufficient to impart the desired oil-solubility to the detergent,

Phenols and/or their phenate salts, from which exemplary overbased metal detergents of the present invention may derive, may be non-sulfurized or sulfurized, but are preferably sulfurized. Further, the term “phenol” as used herein includes phenols that contain more than one hydroxy!group (e.g., alkyl catechols) or fused aromatic rings (e.g., alkyl naphthols); of phenols that have been modified by chemical reactions. Such chemically modified phenols may include, for example, alkylene-bridged phenols; Mannich base condensed phenols; and saligenin-type phenyls produced by a reaction of a phenol and an aldehyde under basic conditions. Preferred phenols may be derived from the formula:

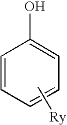

wherein R represents a hydrocarbyl group and y represents 1 to 4. Where y is greater than 1, the hydrocarbyl groups may be the same or different.

In their oft-used sulfurized forms, sulfurized hydrocarbyl phenols may be represented by the formula:

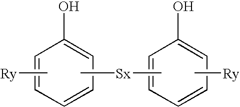

wherein x is generally from 1 to 4. In some eases, more than two phenol molecules may be linked by Sx bridges. In both the formulae above, the hydrocarbyl groups represented by R are advantageously alkyl groups, which may contain 5 to 100, preferably 5 to 40, especially 9 to 12, carbon atoms, with the average number of carbon atoms In all of the R group being at least 9in order to ensure adequate solubility in oil. Preferred alkyl groups are nonyl (tripropylene) groups. Hydrocarbyl-substituted phenols are often also referred to as “alkyl phenols.”

Methods of sulfurizing phenols or phenate are known to those skilled in the art. Specifically, a sulfurizing agent, which introduces the -(Sx)-bridging group, should be used, wherein x is generally from I to about 4. Accordingly the reaction may be conducted with elemental sulfur or a halide thereof. If elemental sulfur is used, the sulfurization reaction may take place after the alkyl phenol compound is heated at from 50 to 250, preferably above 100° C. If a sulfur halide is used, the sulfurization reaction may take place after the alkyl phenol is treated at from −10 to 120, preferably above 60° C. These, reactions arc typically-conducted in the presence of a suitable diluent, which may advantageously comprise a substantially inert organic diluent such as a mineral oil or an alkane. Moreover, where elemental sulfur is used as the sulfurizing agent, it may be desirable to use a basic catalyst such as sodium hydroxide; or an organic amine, preferably a heterocyclic amine such as morpholine.

As indicated above, the term “phenol” as used herein includes phenols that have been modified by chemical reaction with, for example, an aldehyde and Mannich base-condensed phenols. Aldehydes with which phenols may be modified include, for example, formaldehyde, propionaldehyde and butyraldehyde. The preferred aldehyde is formaldehyde. Various aldehyde-modified phenols are described in, for example, U.S. Pat. No. 5,259,967, the disclosures of which, to the extent they are relevant to aldehyde-modification of phenol and to the extent they do not conflict with the disclosures and claims herein, are incorporated by reference. Mannich base-condensed phenols are prepared by the reaction of a phenol, an aldehyde and aft amine. Examples of suitable Mannich base-condensed phenols are described in, for example, GB-A-2 121 432, the disclosures of which, to the extent they are relevant to Mannich-base-condensed phenols, and to the extent they do not conflict with the disclosures and claims herein, are incorporated by reference. In general, the phenols may further include substituents other than those mentioned above, provided that such substituents do not detract significantly from the surfactant properties of the phenols. Examples of such Substituents include methoxy groups and halogen atoms.

Suitable detergents may also originate from, salicylic acids. Salicylic acids used in accordance with the invention may be non-sulfurized or sulfurized, and may be chemically modified and/or contain additional substituents such as, for example, those discussed above for phenols. In alkyl-substituted salicylic acids, the alkyl groups advantageously contain 5 to 100, preferably 9 to 30, especially 14 to 20, carbon, atoms, Processes similar to those described above may also be used to sulfurize a hydrocarbyl-substituted salicylic acid. Salicylic acids are typically prepared by the carboxylation, by the Kolbe-Schmitt process, of phenoxides, and in that instance are generally obtained in admixture with uncarboxylated phenol.

Other suitable detergents may originate from sulfonic acids, which are typically obtained by sulfonation of hydrocarbyl-substituted, especially alkyl-substituted, aromatic hydrocarbons, for example, those obtained from the fraction of petroleum by distillation and/or extraction, or by the alkylation of aromatic hydrocarbons. Suitable sulfonic acids include those obtained by alkylating benzene, toluene, xylene, naphthalene, biphenyl or their halogen derivatives, such as, for example, chlorobenzene, chlorotoluene, or chloronaphthalene. Alkylation of aromatic hydrocarbons may be carried out in the presence of a catalyst with alkylating agents having from 3 to more than 100 carbon atoms, such as, for example, haloparaffins; olefins that may be obtained by dehydrogenation of paraffins; and polyolefins such as polymers of ethylene, propylene, butene and the like. These alkylaryl sulphonic acids typically contain from 7 to 100 or more carbon atoms. They preferably contain from 16 to 80, or 12 to 40, carbon atoms per alkyl-substituted aromatic moiety, depending on the source from which they are obtained. These suitable sulfonic acids are neutralized to provide sulfonates, which process is effectuated optionally in the presence of hydrocarbon solvents and/or diluent oils, as well as promoters and viscosity control agents.

Sulfonic acids from which the metal detergents of the present invention may derive may further include alkyl sulfonic acids and alkenyl sulfonic acids. In such compounds the alkyl group and/or alkenyl group suitably contain 9 to 100, advantageously 12 to 80, especially 16 to 60, carbon atoms.

Yet another type of suitable metal detergents may be derived from carboxylic acids, which typically include mono- and/or dicarboxylic acids. Preferred monocarboxylic acids are those containing 1 to 30, especially 8 to 24, carbon atoms. Examples of monocarboxylic acids are iso-octanoic acid, stearic acid, oleic acid, palmitic acid and behenic acid. An example of a suitable so-octanoic acid may be the mixture of C₈ acid isomers as sold by Exxon Chemicals under the trade name CEKANOIC™. Other suitable carboxylic acids are those with tertiary substitutions at the α-carbon atom and dicarboxylic acids with more than 2 carbon atoms separating the carboxylic groups. Further, dicarboxylic acids with more than 35, for example, 36 to 100, carbon atoms are also suitable. Unsaturated carboxylic acids can optionally be sulfurized. Just as salicylic acids are not classified as phenol detergents herein despite the presence of a hydroxyl group on the aromatic ring, salicylic acids are not regarded as carboxylic acid detergents although they contain a carboxylic group.

Examples of other detergents that may be used in accordance with the invention include the following compounds, and derivatives thereof: naphthenic acids, especially naphthenic acids containing one or more alkyl groups; dialkylphosphonic acids; dialkylthiophosphonic acids; and dialkyldithiophosphoric acids; high molecular weight, and preferably ethoxylated, alcohols; dithiocarbamie acids; and thiophosphines. Examples also include optionally sulfurized alkaline earth metal hydrocarbyl phenates that have been modified by carboxylic acids such as stearic acid, for examples as described in EP-A-271 262; and phenolates as described in EP-A-750 659. The disclosures in these patents, to the extent they do pertain to the modified and optionally sulfurized hydrocarbyl phenates, and to the extent they do not conflict with the disclosures and claims herein, are incorporated by reference.

The detergents discussed above are suitably overbased, which helps to neutralize the sulfonic acid that is inevitably produced in the combustion exhaust when diesel fuels containing sulfur, regardless its level, are used to drive these engines. Suitable overbased metal compounds include alkali metal and alkaline earth metal additives such as overbased oil-soluble or oil-dispersible calcium, magnesium, sodium, or barium, salts of a surfactant selected from phenol, sulfonic acid, carboxylic acid, salicylic acid, and naphthenic acid. The overbasing is typically provided by an oil-soluble salt of the metal, for example, a carbonate, a basic carbonate, an acetate, a formate, a hydroxide, or an oxalate, which is stabilized by the oil-soluble salt of the surfactant. Preferably the metal, whether the metal of the oil-soluble or oil-dispersible salt, is calcium.

Also suitable for use in the present invention are overbased metal detergents, preferably overbased calcium detergents, that contain at least two surfactant groups, such as phenol, sulfonic acid, carboxylic acid, salicylic acid and naphthenic acid, which may be obtained by manufacture of a hybrid material in which two or more different Surfactant groups are incorporated during the overbasing process. The hybrid material can also be obtained by simply physically mixing two or more overbased detergents of different types. Examples of hybrid materials include an overbased calcium salt of surfactants phenol and sulfonic acid; an overbased calcium salt of surfactants phenol and carboxylic acid; an-overbased calcium salt of surfactants phenol, sulfonic acid and salicylic acid; and an overbased calcium salt of surfactants phenol and salicylic acid.

In instances where at least two overbased metal compounds are present, any suitable proportions by mass may be used, preferably the mass to mass proportion of any one overbased metal compound to any other metal overbased compound is In the range of from 5:95 to 95:5, such as from 90:10to 10:90, more preferably from 20:80 to 80:20, advantageously from 70:30 to 30:70, Persons skilled in the art have known and described lubricant oil compositions comprising hybrid overbased detergents in, for example, WO-A-97/46643; WO-A-97/46644; WO-A-97/46645; WO-A-97/46646; and WO-A-97/46647.

The term “an overbased calcium salt of surfactant” refers to an overbased detergent in which the metal cations of the oil-insoluble metal salt are essentially calcium cations. Small amounts of other cations may be present, but typically at least 80, more typically at least. 90, such as at least 95, %, of the cations in the oil-insoluble metal salt, are calcium ions.

The levels of over basing in the metal detergents of the present invention may vary widely, but preferably the TBN of each of the overbased metal detergents is at least 100, or at least 150, or at least 200, such as up to 500. An exemplary diesel cylinder lubricant of the present invention comprises a highly overbased calcium sulfonate detergent having a TBN of about 430.

Typically, the amount of one or more overbased metal detergents in the lubricant is at least 0.5, particularly in the range of from 0.5to 30, such as from 3 to 25, or 2 to 20, or 5 to 22, wt. %, based on total weight of the lubricant oil. An exemplary diesel cylinder lubricant of the present invention comprises about 16 wt. % of a highly overbased sulfonate detergent. At least 90%, more preferably at least 95%, such as at least 98%, of the TBN of the lubricating oil composition of the present invention is provided for by the one or more overbased metal-containing detergents.

The overbased metal compounds of the present invention may also be borated. In that ease, the boron-contributing compound, such as the metal borate, is considered to form pail of the overbasing.

### 4. Foam Inhibitors

Foam forms when a large amount of gas is entrained in a liquid. While foaming is desirable in certain applications, such as floatation washing and cleaning, it is undesirable in others. In lubricant-related applications, foaming can be an impediment because it leads to ineffective lubrication. Over time, it may also cause oxidative degradation of the lubricant. The viscosity and surface tension of a lubricant determine the stability of the foam. Low-viscosity oils produce foams with large bubbles, which tend to break quickly and be minimally problematic. But high-viscosity oils, such as those used in the diesel cylinder lubricants of the present invention, generate stable foams that contain fine bubbles and are difficult to break. The presence of surface-active materials, such as for example, the surfactant materials of the present invention, detergents, and/or dispersants, further increases the lubricant's tendency to foam,

Foam inhibitors control foam formation by altering the surface tension of the oil and by facilitating the separation of the air bubbles from the oil phase. In general, these additives have limited solubility in oil, thus they are typically added as fine dispersions. Silicones (e.g., polysiloxanes), polyalkyl acrylates, and polyalkyl metacrylates are foam inhibitors that can be suitably used in the diesel cylinder lubricants of the present invention, with silicones being more preferred. An exemplary diesel cylinder lubricant of the present invention comprises about 0.06 wt. % of a silicon-based foam inhibitor.

### 5. Other Additives

The diesel cylinder lubricant of the present invention may include as co-additives one or more other wear inhibitors, as well as various other materials. Such other materials Include, for example, antioxidants, antifoaming agents, and/or rust inhibitors. Further details of exemplary co-additives are described below:

A. Zinc-Containing Wear Inhibitor

Depending upon the type of application used, the diesel cylinder lubricating oil composition can further comprise from about 0.1 wt. % to about 2 wt. % of at least one zinc dithiophosphate wear-inhibition additive. That zinc dithiophosphate wear-inhibition additive is-particularly useful in ships, workboats and stand-by or continuous electrical power generation, where the additive may be a zinc dialkyldithiophosphate derived from primary alcohols.

For marine applications, a particular physical mixture of zinc dialkyl-dithiophosphates maybe preferred because it increases the water tolerance of diesel engines that are susceptible to water contamination. That physical mixture may have from about 20 wt. % to about 90 wt. %, preferably from about 40 wt. % to about 80 wt. % of a zinc dialkyl-dithiophosphate derived from only primary alkyl alcohols, and from about 10 wt. % to about 80wt. %, preferably from about 20 wt. % to about 60 wt. %, of a zinc dialkyl-dithiophosphate derived from only secondary alkyl alcohols. This physical mixture of zinc dialkyl-dithiophospbates differs from chemical mixtures of zinc diaikyl-dithiophosphates derived from mixtures of different types of alcohols.

The individual zinc dialkyldithiopbosphates can be produced from dialkyldithiophosphoric acids of the formula:

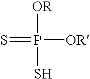

The hydroxy alkyl compounds from which the dialkyldithiophosphoric acids are derived can be represented genetically by the formula ROH or R′OH, where R or R′ is alkyl or substituted alkyl group. Preferably, R or R′ is a branched or non-branched alkyl containing about 3 to about 20, or more preferably, about 3 to about 8, carbon atoms.

Individual dialkyldithiophosphoric acids can also be produced from hydroxy alkyl compounds. As is recognized in the art, these hydroxy alkyl compounds need not be monohydroxy alkyl compounds. That is, the dialkyldithiophosphoric acids may be prepared from mono-, di, tri, terra-, and other polyhydroxy alkyl compounds, or mixtures of two or more of the foregoing. Most commercially available alcohols can be used for this purpose because they are typically not pure compounds but are mixtures containing a predominant amount of the desired alcohol and minor amounts of various isomers and/or longer- or shorter-chain alcohols.

Preferably, a zinc dialkyldithiophosphate derived from only primary alkyl alcohols Is derived from a single primary alcohol. Preferably, that single primary alcohol is 2-ethylhexanol. Preferably, a zinc dialkyldithiophosphate derived from only secondary alkyl alcohols is derived from a mixture of secondary alcohols. Preferably, that mixture of secondary alcohols is a mixture of 2-butanol and 4-methyl-2-pentanol. The phosphorus pentasulfide reactant used in the dialkyldithiophosphoric acid formation step of this invention may also contain minor amounts of any one or more of P₂S₃. P₄S₃, P₄S₇, or P₄S₉. Such phosphorus sulfide compositions may contain minor amounts of free sulfur. It should be noted that, while the structure of phosphorus pentasulfide is generally represented as P₂S₅, the actual structure is believed to contain four phosphorus atoms and ten sulfur atoms, i.e., P₄S₁₀. For the purposes of this Invention, the phosphorus sulfide reactant will be considered as a compound having the structure: of P₂S₅ with the understanding that the actual structure is probably P₄S₁₀.

B. Oxidation Inhibitors

Oxidation inhibitors, or antioxidants, reduce the tendency of mineral oils to deteriorate in service, evidence of such deterioration being, for example, the production of varnish-like deposits on metal surfaces and of sludge, and viscosity increase. Suitable oxidation inhibitors include, for example, sulfurized alkyl phenols and alkali or alkaline earth metal salts thereof: diphenylamines; phenyl-nehthylamines; and phosphosulfurized or sulfurized hydrocarbons. Other oxidation inhibitors or antioxidants include various oil-soluble copper compounds. The copper may, for example, be in the form of a copper dihydrocarbyl thio- or dithio-phosphate. Alternatively, the copper may be added as the copper salt of a synthetic or natural carboxylic acid such as, for example, a C₈ to C₁₈ fatty acid, an unsaturated acid, or a branched carboxylic acid. Also useful are oil-soluble copper dithiocarbamates, sulfonates, phenates, and acethylacetonates. Examples of particular useful copper compounds include basic, neutral, or acidic copper Cu. I and/or Cu II salts derived from alkenyl succinic acids or anhydrides.

C. Ashless Dispersants

Dispersants are additives that suspend oil-insoluble resinous oxidation products and particulate contaminants in the bulk oil. Persons skilled in the art often add various dispersants to lubricating oils to minimize sludge formation, particulate-related abrasive wear, viscosity increase, and oxidation-related deposit formation.

It is known that dispersants perform these functions via one or more means selected from: (1) solubilizing polar contaminants in their micelles; (2) stabilizing colloidal dispersions in order to prevent aggregation of their particles and their separation out of oil; (3) suspending such products, if they form, in the bulk lubricant; (4) modifying soot to minimize its aggregation and oil thickening; and (5) lowering surface/interfacial energy of undesirable materials to decrease their tendency to adhere to surfaces. The undesirable materials are typically formed as a result of oxidative degradation of the lubricant, the reaction of chemically reactive species such as carboxylic acids with the metal surfaces in the engine, or the decomposition of thermally unstable lubricant additives such as, for example, extreme pressure agents.

In diesel-fueled engines such as the 2-stroke diesel engines of the present invention, soot from the combustion chamber is the key component of carbon and lacquer deposits that occur on pistons, and sludge. These deposits result when soot combines with resin. In general lacquer is rich in resin and carbon is rich in soot. Sludge results when soot combines with oxygenated species, oil, and water. Local piston temperatures and the lubricant's ash-producing tendency have also profound effects on the composition of the carbon deposits. Dispersants suppress the interaction between resin and soot particles, by preferentially associating with them and, at the same time, keeping them suspended in the bulk lubricant. Since both resin and soot particles are polar in character, either by their very nature or due to adsorbed polar impurities, the dispersant associates with these particles via its polar end.

A typically dispersant molecule comprises three distinct structural features: (1) a hydrocarbyl group; (2) a polar group: and (3) a connecting group or a link. The hydrocarbyl group Is typically polymeric in nature, and may have a molecular weight of at or above about 2000 Daltons, preferably at or above about 3000 Daltons, more preferably at or above about 5000 Daltons, and even more preferably at or above about 8000 Daltons. A variety of olefins, such as poly isobutylene, polypropylene, polyalphaolefins, and mixtures thereof can be used to make suitable polymeric dispersants. Among suitable polymeric dispersants. polyisohutylene-derived dispersants are the most common. Typically the number average molecular weight of polyisobutylene in those dispersants ranges between about 500 and about 3000Daltons, or, in some embodiments, between about 800 to about 2000 Daltons, or in limber embodiments, between about 1000 to about 2000 Daltons. Molecular weight distribution and the length and degree of branching are, like the number average molecular weight of the polyisobutylenes, important to the effectiveness as a dispersant. In a given dispersant, the polar group is usually nitrogen- or oxygen-derived. Nitrogen-based dispersants are typically derived from amines. The amines from which the nitrogen-based dispersants are derived are often polyalkylenepolyamines, such as, for example, diethylenetriamine and trethylenetetramine. Amine-derived dispersants are also called nitrogen- or amine-dispersants, while those derived from alcohol are also called oxygen or ester dispersants. Oxygen-based dispersants are typically neutral while the amine-based dispersants are typically basic. Chemical classes suitable for use as dispersants include alkenylsuccinimides, alkenyl succininate esters, high molecular weight amines, Mannich bases, and phosphonic acid derivatives. Polyisobutenyl succinic acid derivatives such as succinimides and succinate esters are commercially the most commonly used dispersant types.

Lubricating oil compositions of the present invention may comprise an amount of an ashless dispersant that is sufficient to measurably reduce the amount of soot deposits on the cylinders and/or sludge formation. By “measurably reduce” it is meant that the reduction can be measured by standard testing methods such as, for example, the ASTM Sequence VE/VG Test and Caterpillar IK, 1M-PC, IN, IP, and IR tests. It typically refers to a level of reduction that is at least 2%, or at least 5%, or more preferably, at least 10% of the level prior to treatment by the dispersants. Suitable diesel cylinder lubricating oil compositions of the present invention comprise about 0.1 to about 5 wt. %, such as about 0.2 to abotit 2 wt. %, or about 0.5 to about 1 wt. % of one or more ashless dispersants.

D. Rust Inhibitors

Marine diesel engines, as their names suggest, operate in omnipresence or near omnipresence of sea water, which typically contains large amounts of various salts. Stationary large diesel engines in power plants also operate in the presence of water. Rust forms when an electrochemical corrosive reaction takes place in the presence of electrolytes such as, for example, water, acids, alkalis, and salts. Electrochemical corrosion or the rusting process involves the reaction of metals in the presence of electrically conducting solutions, or electrolytes, and occurs in two stages: (1) the anodic process and the cathodic process. In the anodic process, metal goes into solution as ions with extra electrons left over. The process is also often regarded as an oxidation process. The cathodic process involves the reaction of thus generated electrons with water and oxygen to form the hydroxide ions. This process is also often considered a reduction process. In solution, the metal ions then combine with hydroxide ions to form metal hydroxide, or hydrated oxides. The speed of electrochemical corrosion depends upon the nature of the metal oxide film, the presence or absence of polar solvent such as water, the presence or absence of an electrolyte (salts, acids or bases), and the temperature.

Protection against rust is an important consideration in formulating lubricants for marine diesel engines for the obvious reason that the environments in which such engines operate are rife with the elements that can lead to rust. Such protection is likewise important for stationary operations of 2-stroke engines. Without protection, rust ultimately causes a loss of metal, thereby lowering the integrity of the equipment, and resulting in engine malfunction. In addition, corrosion exposes fresh metal that can wear at an accelerated rate, perpetuated by the metal ions that have been released into the fluid and are now acting as oxidation promoters.

For protection, rust inhibitors are used. They attach themselves to metal surfaces to form an impenetrable protective film, which can be physically or chemically adsorbed to the surface. Specifically, film formation occurs when the additives interact with the metal surface via their polar ends and associate with the lubricant via their nonpolar ends, in a manner similar to that of friction modifiers. Suitable rust Inhibitors may include, for example, various nonionic polyoxyethylene surface active agents such as polyoxyethylene lauryl ether, polyoxyethylene higher alcohol ether, polyoxyethylene nonylphenyl ether, polyoxyethylene octylphenyl ether, polyoxyethylene octyl stearyl ether, polyoxyethylene oleyl ether, polyoxyethylene sorbitol monostearate, polyoxyethylene sorbitol mono-oleate, and polyethylene glycol monooleate. Suitable rust inhibitors may further include other compounds such as, for example, stearic acid and other fatty acids, dicarboxylic acids, metal soaps, fatty acid amine salts, metal salts of heavy sulfonic acid, partial carboxylic acid ester of polyhydric alcohol, and phosphoric ester.

E. Demulsifiers

In the presence of water, lubricant oil compositions taken on an increased tendency to form emulsions. The diesel cylinder lubricants of the present invention are used to lubricate marine diesel engines or stationary diesel engines that operate in environments where water contamination is often an unavoidable problem. To combat the operational drawbacks associated with the formation of excess emulsions, demulsifiers are added to such formulations to enhance water separation and suppress foam formation. Typically, most demulsifiers are oligomers or polymers with a molecular weight of up to about 100,000 Daltons and contain about 5 to about 50% polyethylene oxide in a combined form. Commonly used demulsifiers include block copolymers of propylene oxide or ethylene oxide and initiators, such as, for example, glycerol, phenol, formaldehyde resins, soloxanes, polyamines, and polyols. To prevent common water-in-oil emulsions, polymers containing about 20 to about 50% ethylene oxide are suitable. These materials concentrate at the water-oil interlace and create low viscosity zones, thereby promoting droplet coalescence and gravity-driven phase separation. Low molecular weight materials, such as, for example, alkali metal or alkaline earth metal salts of dialkylnaphthalene sulfonic acids, are also useful in certain applications.

F. Antiwear and/or Extreme Pressure Agents

Wear occurs in all equipment that has moving parts in contact. Specifically, three conditions commonly lead to wear in diesel engines: (1) surface-to-surface contact; (2) surface contact with foreign matter; and (3) erosion due to corrosive materials. Wear resulting from surface-to-surface contact is friction or adhesive wear, from contact with foreign matter is abrasive wear, and from contact with corrosive materials is corrosive wear. Fatigue wear is an additional type of wear that is common in equipment where surfaces are not only In contact but also experience repeated stresses for prolonged periods. Abrasive wear can be prevented by installing an efficient filtration mechanism to remove the offending debris. Corrosive wear can be addressed by using additives such as those described above, which neutralize the reactive species that would otherwise attack the metal surfaces. The control of adhesive wear requires the use of additives called antiwear and extreme-pressure (EP) agents.

Under optimal conditions of speed and load, the metal surfaces of the equipment should be effectively separated by a lubricant film. Increasing load, decreasing speed, or otherwise deviating from such optimal conditions promote metal-to-metal contact. This contact typically causes a temperature increase in the contact zone due to frictional heat, which in turn leads to the loss of lubricant viscosity and hence its film-forming ability. Antiwear additive and EP agents offer protection by a similar mechanism, although EP additives typically require higher activation temperatures and load than antiwear additives.

Antiwear and/or EP additives function by thermal decomposition and by forming products that react with the metal surface to form a solid protective layer. This solid metal film fills the surface asperities and facilitates effective film formation, thereby reducing friction and preventing welding and surface wear.

Most antiwear and extreme pressure agents contain sulfur, chlorine, phosphorus, boron, or combinations thereof. The classes of compounds that inhibit adhesive wear include, for example, alkyl and aryl disulfides and polysulfides; dithiocarbamates; chlorinated hydrocarbons; and phosphorus compounds such as alkyl phosphites, phosphates, dithiophosphates, and alkenylphosphonates.

Various commonly used antiwear agents can be included in the diesel cylinder lubricant oil compositions of the present invention. For example, zinc salts of dithiohosphoric acids, in addition to providing antiwear protection oiler additional benefits as oxidation and corrosion inhibitors. These salts may include, for example, zinc dialkyl dithiophosphates and zinc diaryl dithiophosphates. Methods of making zinc-salts suitable for this purpose are known in the art. Moreover, alkyl and aryl disulfides and polysulfides, dithiocarbamates, chlorinated hydrocarbons, dialkyl hydrogen phosphites, and salts of alkyl phosphoric acids can also be suitable EP agents. Methods of making these EP agents are known in the art. For example, polyulfides are synthesized from olefins either by reacting with sulfur or sulfur halides, followed by dehydrohalogenation. Dialkydithiocarbamates are prepared either by neutralizing dithiocarbamic acid (which can be prepared by reacting a diakylamine and carbon disulfide at low temperature) with bases, such as zinc oxide or antimony oxided, or by its addition to activated olefins, such as alkyl acrylates.

One or more EP agents may be used for purpose of the present invention. Specifically, the use of more than one EP agents may lead to synergism. For example, synergism may be observed between sulfur and chlorine-containing EP agents. An exemplary diesel cylinder lubricant of the present invention may include as an EP agent one or more materials selected from: zinc dialkyldithiophosphate (primary alkyl type & secondary alkyl type), sulfurized oils, diphenyl sulfide, methyl trichlorostearate, chlorinated naphthalene, fluoroalkylpolysiloxane, and lead naphthenate.

G. Friction Modifiers

Friction modifiers are agents that modify the frictional properties of a lubricant. They are typically long-chain molecules with a polar end group and a nonpolar linear hydrocarbon chain. The polar end groups either physically adsorb onto the metal surface or chemically react with it, while the hydrocarbon chain extend into the lubricant. The chains associated with one another and the lubricant to form a strong lubricant film.

Suitable friction modifiers may include, for example, fatty alcohols, fatty acids, fatty amides, and molybdenum compounds. For the fatty alcohol and fatty acid families of compounds, friction-modifying properties are a function of the length and the structure of the hydrocarbon chain and the nature of the functional group. Long and linear chain materials reduce friction more effectively than short and branched chain materials. Also, fatty acids are typically better friction modifiers than fatty amides, which in turn are better than fatty alcohols. Saturated acids, containing a 13 to 18 carbon chains, are generally preferred. Lower molecular weight fatty acids are avoided because of their corrosivity. Fatty acid derivatives are also among the most commonly used friction modifiers. Exemplary diesel cylinder lubricants of the present invention may comprise as friction modifiers one or more materials selected from: fatty alcohols, fatty acids, amines, and borated or other esters.

H. Multi-Functional Additives

Various additives mentioned or not mentioned herein can provide a multiplicity of effects to the diesel cylinder lubricant oil composition of the present invention. Thus, for example, a single additive may act as a dispersant as well as an oxidative inhibitor. Indeed, the corrosive-wear inhibiting and/or reducing surfactant materials of the present invention may serve as multi-functional additives, providing the lubricant oil compositions with capacities to reduce and/or inhibit corrosive wear on the power cylinders as well as dispersancy. Multi-functional additives are well known in the art. Other suitable multi-functional additives may include, for example, sulfurized oxymolybdenum dithiocarbamate, sulfurized oxy molybdenum organo pohosphoro dithioate, oxymolybdenum monoglyceride, amine-molybdenum complex compound, and sulfur-containing molybdenym complex compounds,

I. Pour Point Depressants

The pour point is the lowest temperature, at which an oil will pour when cooled under defined conditions. In general, the pour point is indicative of the amount of straight-chain paraffins in an oil. At low temperature, straight-chain paraffins tend to separate as crystals with a lattice type structure. These crystals can trap a substantial amount of oil via association, inhibit oil flow, and ultimately hinder proper lubrication of the equipment. Although base oil suppliers make an effort to remove most of the straight-chain paraffins, complete removal of those molecules is often not practical due to process limitations and economics. Also, these molecules may offer beneficial viscosity characteristics. Thus, for operations at low temperatures, persons skilled in the art typically favor incomplete removal of straight-chain paraffin molecules in combination with the use of pour point depressants in the lubricant oils.

Pour point depressants generally possess one or more structural features selected from: (1) polymeric structure; (2) waxy and non-waxy components; (3) comb structure comprising a short backbone with long pendant groups; and (4) broad molecular weight distribution. Many polymeric pour point depressants are known in the: art and some are commercially available. Most commercial pour point depressants are organic polymers, although some nonpolymeric materials have also been shown to be effective, including, for example, tetra (long-chain) alkyl silicates, phenyltrstearyloxysilane, and pentaerythritol tetrastearate. Examples of suitable pour point depressants include alkylated naphthalenes, poly(alkyl methacrylates), poly(alkyl fumarates), styrene esters, oligomerized alkyl phenols, phthalic acid, esters, ethylene-vinyl acetate copolymers, and other mixed hydrocarbon polymers. Pour point depressants are typically used at treatment levels at or below about 1 wt. %.

### 6. 2-Cycle Diesel Engine Cylinder Lubricating Oil Composition

The present invention pertains to a lubricating oil composition suitable for use in a slow- or medium-speed diesel engine that operates on the 2-stroke cycle. This lubricating oil composition comprises:

(a) a major amount of a base oil of lubricating viscosity;

(b) one or more of oil-soluble surfactant materials as described above, in a combined amount sufficient to substantially reduce the corrosive wear on the power cylinders of the 2-stroke diesel engines;

(e) one or more overbased metal detergents in a combined amount sufficient to give the lubricant oil composition a total TBN of about 5 to 100, preferably of about 30 to about 50, or of about 60 to 80; and

(d) a minor amount of one or more foam inhibitors.

The term “substantially reduce” refers to a reduction of at least about 5%, preferably at least about 10%, more preferably at least about 15%, as compared to the amount of measurable corrosive wear on the power cylinders when they are lubricated by a comparative composition containing no surfactant material of the present invention.

That diesel cylinder lubricant oil composition can further comprise other additives as exemplified and described herein.

In a further embodiment, a diesel cylinder lubricant, oil composition is produced by blending a mixture of the above components. The lubricating oil composition produced by that method may have a slightly different composition than the initial mixture, because the components may interact with each other. The components can be blended in any order and can be blended as combinations of components.

Lubricating the power cylinders of 2-stroke diesel engines with the lubricating oil compositions of the present Invention can provide enhanced protection to these cylinders against corrosive wear. The lubricating oil compositions of the present invention may also include one or more other additives such as, for example, a high TBN metal detergent, which provides certain baseline level of protection against corrosive wear. If so, then the protective effect of the surfactant materials of the present invention is above and beyond the protective effects provided by the additional, high TBN, corrosive-wear controlling additives.

### 7. Additive Concentrates

Additive concentrates are also within the scope of the present invention. The concentrates of this invention comprise the surfactant materials described above, preferably with at least one overbased metal detergent, at least one foam inhibitor, and at least one other additive, as disclosed above. The concentrates contain sufficient organic diluent to make them easy to handle during shipping and storage, especially when they are carried and blended onboard oceangoing vessels during long voyages.

Suitably, from about 20 wt. % to about 80 wt. % of each concentrate is organic diluent. Organic diluents that can be used include, for example, mineral oils or synthetic oils, just like those described above in the “Oil Of Lubricating Viscosity” section.

This invention will be further understood by reference to the following examples, which are not to be considered as limitative of its scope.

### EXAMPLES

The following examples are provided to illustrate the present invention without limiting it. While the present invention has been described with reference to specific embodiments, this application is intended to encompass those various changes and substitutions that may be made by those skilled in the art without departing from the spirit and scope of the appended claims.

### Example 1

### A Low TBN Sulfonate Surfactant Improves Corrosive Wear Control

Various diesel cylinder lubricant oil samples were prepared. Their capacities to control corrosive wear were measured in a Falex™ Pin and Vee-Block Test. Specifically, the test was carried out in a standard Falex™ Pin and Vee-Block Lubricant Test Machine (Falex Corporation, Aurora, Ill.). The test was carried out in two phases: (1) a run-in phase; and (2) a test phase. During the run-in phase, a steel pin was rotated between two steel Vee-blocks that were Immersed in the oil sample to be tested. The Vee-blocks were pressed against the pin at a predetermined load of 445 Newtons for about 900 seconds. The test phase followed the run-in phase, where the oil temperature remained at 80° C. During the test phase, however, the Vee-blocks were pressed against the test pin with a load of 1335 Newtons. A peristaltic pump having a tube with an inner diameter of 0.5 mm was used to deliver sulfuric acid (at a concentration of 3N in water) to the test pin, which was located about 1 mm away from the opening of the tube, by spraying the acid onto the pin, at a flow rate of about 7.5 ml/hour. The test phase lasted about 7200 seconds. The Vee-block used was a standard-coined Vee-Block with a 96±1° angle, made with AISI C-1137 steel (hardness: HRC 20-24, rms) (available from Falex™ Corp.). The test pin used was a standard test pin, with a 6.35 mm outside diameter and 31.75 mm length, made with AISI 3135 steel (hardness HRB 87-91, rms) (also available from Falex™ Corp.). The weight of the pin was measured before the test and after the completion of the test phase. The weight Joss was used to indicate the extent or level of wear.

Each of Samples A and B comprised an oil of lubricating viscosity, an oil-soluble surfactant material, a highly overbased sulfonate detergent, and a foam inhibitor. Comparative Sample C comprised the same set of components as in. Sample A or B, except that Comparative Sample C did not comprise either the 17 TBN sulfonate surfactant or the non-overbased linear alkyphenol surfactant. Components of these samples are listed below in Table 1.

The results of the Falex™ Pin and Vee-Block Test are also listed in Table 1. Accordingly, a diesel cylinder lubricant oil's capacity to resist corrosive wear was substantially improved, as a result of including, a low-TBN sulfonate surfactant. Moreover, such an improvement was also apparent when the diesel cylinder lubricant oil comprised a non-overbased Song-chain alkylphenol surfactant.

TABLE 1

| Formulations | A | B | C |
|---|---|---|---|
| Additives: | | | |
| TBN 17 sulfonate surfactant | 7.71 wt. % | | |
| C₁₈–C₂₈ Alkylphenol | | 6.90 wt. % | |
| surfactant | | | |
| TBN 430 Sulfonate Detergent | 16.04 wt. % | 16.32 wt. % | 16.32 wt. % |
| Silicon-based foam inhibitor | 0.06 wt. % | 0.06 wt. % | 0.06 wt. % |
| TBN | 70 | 70 | 70 |
| Esso Core 600 Base | 47.93 wt. % | 39.32 wt. % | 47.68 wt. % |
| Oil (600N) | | | |
| Esso Core 2500 | 28.26 wt. % | 37.40 wt. % | 35.94 wt. % |
| (150 Brightstock) | | | |
| Bench Test Results: | | | |
| Falex ™ Pin Weight | 20 | 79 | 186 |
| Loss (mg) | | | |

### Example 2

### Prophetic Example

Each of Samples D and E is prepared to comprise a major amount of an oil of lubricating viscosity, and a minor amount of a foam inhibitor. Samples D and E further comprise about 9.00 wt. % and about 9.30 wt. % of a 430 TBN calcium sulfonate detergent, respectively, bringing the TBN of each lubricating oil composition to about 40, Sample 0 comprises about 7.71 wt. % of a 17 TBN sulfonate sarfactanf Sample E comprises about 6,90 wt. % of a non-overbased linear alkylpheno 1 surfactant.

Comparative Sample F is prepared to comprise the same components as Sample D or E, except that Comparative Sample F does not contain either the 17 TBN sulfonate surfactant or the non-overbased linear alkyphenol surfactant.

The pins in the Falex™ Pin and Vee-Block Test are measured for weight losses. The pins tested in the presence of Sample Oils C and D are expected to lose substantially ess weight than the pins tested in the presence of Comparative Sample F.

What is claimed is:

1. A diesel cylinder lubricating oil composition comprising an admixture of:
(a) a major amount of an oil of lubricating viscosity;
(b) one or more metal-containing detergents;
(c) one or more foam inhibitors; and
(d) a corrosive-wear inhibiting amount of one or more oil-soluble surfactant materials;
wherein the lubricating oil composition has a TBN of about 5 to about 100.

2. The lubricating oil composition of claim 1, having a TBN of about 30 to about 50.

3. The lubricating oil composition of claim 1, having a TBN of about 60 to about 80.

4. The lubricating oil composition of claim 1, wherein one of the one or more oil-soluble surfactants is either a low TBN sulfonate surfactant or a non-overbased sulfonate surfactant.

5. The lubricating oil composition of claim 4, wherein the low TBN sulfonate surfactant is a calcium sulfonate surfactant having a TBN of about 2 to about 20.

6. The lubricating oil composition of claim 1, wherein one of the one or more oil-soluble surfactants is a non-overbased linear alkylphenol surfactant.

7. The lubricating oil composition of claim I, wherein the one or more surfactants are present in an amount of about 2 wt. % to about 25 wt. %.

8. The lubricating oil composition of claim 7, wherein the one or more surfactants are present in an amount of about 4 wt. %. to about 20 wt. %.

9. The lubricating oil composition of claim 8, wherein the one or more surfactants are present in an amount of about 5 wt. % to about 15 wt. %.

10. The lubricating oil composition of claim 1, where in at least 90% of the TBN of the lubricating oil composition is provided for by the one or more metal-containing detergents.

11. The lubricating oil composition of claim 10, wherein at least 95% of the TBN of the lubricating oil composition is provided for by the one or more metal-containing detergents.

12. The lubricating oil composition of claim 1, wherein one of the one or more metal-containing detergents is a high-overbased calcium sulfonate detergent.

13. The lubricating oil composition of claim 1, wherein the amount of the one or more metal-containing detergents is at least about 0.5 wt. %.

14. The lubricating oil composition of claim 13, wherein the amount of the one or more metal-containing detergents is about 0.5 wt. % to about 30 wt. %.

15. The lubricating oil composition of claim 14, wherein the amount of the one or more metal-containing detergents is about 3 wt. % to about 25 wt. %.

16. The lubricating oil composition of claim 15, wherein the amount of the one or more metal-containing, detergents is about 5 wt. % to about 22 wt. %,

17. The lubricating oil composition of claim 1, wherein the one or more metal-containing detergents are hybrid overbased metal-containing detergents that are mixtures of at least two overbased metal-containing detergents.

18. The lubricating oil composition of claim 1, further comprising one or more additives selected from: (1) zinc-containing wear inhibitors; (2) oxidation inhibitors; (3) rust inhibitors: (4) pour point depressants; (5) demulsifiers; (6) ashless dispersants; (7) friction modifiers; (8) extreme-pressure agents: and (9) multi-functional additives.

19. A method of providing enhanced corrosive wear control on the cylinders of a 2-stroke diesel engine, comprising:
(a) contacting at least some of the surfaces of the cylinders with a lubricating oil composition of claim 1; and
(b) operating the 2-stroke diesel engine in the presence of the lubricating oil composition.

20. The method according to claim 19, wherein the 2-stroke diesel engine is a slow-speed marine diesel engine or a medium-speed marine diesel engine.

21. The method according to claim 19, wherein the lubricating oil composition further comprises one or more additives selected from: (1) zinc-containing wear Inhibitors; (2) oxidation inhibitors; (3) rust inhibitors; (4) pour point depressants; (5) demulsifiers; (6) ashless dispersants; (7) friction modifiers; (8) extreme-pressure agents; and (9) multi-functional additives.

22. A method of making a lubricating oil composition comprising blending the following components:
(a) an oil of lubricating viscosity;
(b) one or more metal-containing detergents;
(c) one or more foam inhibitors; and
(d) one or more oil-soluble surfactant materials;
so that the TBN of the lubricating oil composition is from about 5 to about 100.

23. The method according: to claim 22, wherein the TBN of the lubricating oil composition is either from about 30 to about 50 or from about 60 to about 80.

24. The method according to claim 22, wherein one or more additives selected from: (1) zinc-containing wear inhibitors; (2) oxidation inhibitors; (3) rust inhibitors; (4) pour point depressants; (5) demulsifiers; (6) ashless dispersants; (7) friction modifiers; (8) extreme-pressure agents; and (9) multi-functional additives, are further blended into the lubricating pit composition.

25. An oil concentrate comprising:
(a) about 20 wt. % to about 80 wt. % of a diluent;
(b) one dr more oil-soluble surfactant materials;
(c) one or more metal-containing detergents; and
(d) one or more foam inhibitors.

26. The oil concentrate of claim 25, wherein one of the one or more surfactant materials is a low TBN sulfonate surfactant.

27. The oil concentrate of claim 26, wherein one of the one or more surfactant materials is a non-overbased linear alkylphenol surfactant,

28. A method of lubricating the cylinders of a 2-stroke diesel engine, comprising:
(a) blending the oil concentrate of claim 25 into a lubricating, oil composition of proper TBN according to the sulfur levels in the diesel fuels employed in the diesel engine; and
(b) operating tile diesel engine in the presence of the lubricating oil composition of (a).
